(19) United States
(12) Patent Application Publication
(10) Pub. No.: US 2023/0023450 A1
(43) Pub. Date: Jan. 26, 2023

(54) CONCRETE SCREW FOR FASTENING PARTS TOGETHER AND AS A LEVELING DEVICE AND METHOD OF MANUFACTURING SAME

(71) Applicant: Carl steadly, montecito, CA (US)

(72) Inventors: Michael Taylor, Carlsbad, CA (US); David Bucknell, Kingman, AZ (US)

(73) Assignee: Carl steadly, montecito, CA (US)

(21) Appl. No.: 17/812,436

(22) Filed: Aug. 25, 2022

Related U.S. Application Data
(63) Continuation-in-part of application No. 17/366,153, filed on Jul. 2, 2021, now abandoned.

(51) Int. Cl. A47B 91/02; F16B 35/00

(52) U.S. Cl. CPC A47B 91/022; F16B 35/00

(57) ABSTRACT

A concrete system comprising a concrete threaded rod and a concrete part having a threaded aperture for receiving the concrete threaded rod.

### BACKGROUND OF INVENTION

### 1. Field of the Invention

The present invention relates to the concrete screws and a concrete receiving part in use as rust-proof levelers in outdoor furniture, and simply as a device for fastening two concrete parts together.

### 2. Background of the Invention

Although concrete screws have been disclosed in the prior art, their use has been limited.

Levelers used to adjust the height of lawn furniture have been available in prior art. For example, U.S. Pat. No. 8,407,855 to Gagnon discloses a support for positioning on the base of a lawn furniture leg of various shapes and dimensions. The support has an area that is at least five times the area of the bottom of the leg to distribute the load over a large area permitting easy sliding of the leg across a lawn. The support prevents prolonged contact of the leg with a source of moisture and provides venting to the bottom of the leg to minimize dry rot. However, the leveler disclosed in the Gagnon patent comprises a structure which likely is expensive to manufacture and, as a result, costly to potential purchasers of the leveler.

Design Pat. No. D875,514 to Zhong shows a concrete screw having a ring groove. However, the functional use of the screw is not disclosed.

US Publication No. US2002/0096127 discloses a set restraint device which is composed of a concrete block having a ringed pin disposed in a recess formed in the top surface of the concrete block, the concrete block being embedded in a lawn.

What is desired is to provide a leveler system that is simple, and which can adjust the height of objects while they are on an uneven surface and thus prevent the rocking movement of those objects. The primary system components are to be moisture resistant, non-electrically conductive, chemically resistant and rust resistant.

### SUMMARY OF THE PRESENT INVENTION

The present invention provides a leveling system primarily adapted to adjust the height of objects, such as lawn furniture, fire pits, outdoor fireplaces and also capable of preventing the rocking motion of objects positioned on uneven surfaces. The system comprises a concrete threaded rod that has a matching internal thread formed in a member that supports the legs of the object. Adjusting the position of the threaded rod in the internal thread adjusts the height of the object and also prevents rocking motion when the object is positioned on an uneven surface. The concrete screw and threaded member are manufactured using a casting, or molding process. A concrete nut is also formed during this process.

The present invention thus provides an object leveling and anti-rocking system which utilizes a concrete screw (one cast concrete piece comprising the nut on top, the threaded rod in the center and a molded concrete foot on the bottom). The threaded rod (female portion) has internal threads formed, in the case of furniture, within the bottom thereof. The advantages of using such a screw with objects, such as lawn furniture, are as follows:
1. Rust resistant.
2. Concrete leveling feet can be manufactured which matches the color and texture of the object being leveled.
3. Concrete leveling feet are less expensive to manufacture than metal levelers.
4. The concrete screws are manufactured using the casting (molding) method which enables various screw shapes, the molding techniques being relatively inexpensive.
5. Concrete leveling feet (screws) can have larger threads thus allowing a concrete threaded hole (concrete nut) to be cast directly into the receiving precast part.
6. Thermal expansion and contraction rates of the concrete screw and the corresponding receiving part are similar thus reducing the effects of concrete cracking.
7. Concrete leveling feet can be used in pools without the necessity of providing an electrical ground while providing a non-conductive part which can be submerged in the pool without the problems associated with metal parts.
8. Leveling feet provide needed ventilation for the fire feature objects without impacting the design of the fire feature.
The present invention also provides a concrete based system for fastening together two or more objects. In addition, the present invention provides a way to adjust the position of an object in relation to another by rotating the concrete screw and/or the nut to produce a linear or rotational motion to position other components, such as gems, latches, earns or other mechanism.

### DESCRIPTION OF TEE DRAWINGS

For a better understanding of the present invention as well as other objects and further features thereof, reference is made to the following description which is to be read in conjunction with the accompanying drawing wherein:

FIGS. 1(a) and 1(b) are views of the concrete screw secured in the concrete mounting part;

FIG. 2 is a bottom view of afire object having the concrete screws mounted to the bottom surface of an object;

FIG. 3 is a view illustrating in more detail how the screw is mounted to the fire object;

FIG. 4 is a perspective view illustrating one-half of the mold used to cast the concrete screws;

FIG. 5 is a perspective view of an assembled furniture piece;

FIG. 6 is furniture piece of FIG. 5 disassembled;

FIG. 7 illustrates the concrete threaded rod; and

FIG. 8 illustrates the threaded rod inserted into a threaded aperture formed in a concrete receiving part.

### DESCRIPTION OF THE INVENTION

FIG. 1(a) illustrates a concrete threaded rod, or screw, 10 having a thread pitch of a predetermined length (for example, a length of 0.434 inch causes the screw to travel one full screw revolution) and having a predetermined screw width of, for example, 1.50 inches. Note that these dimensions are exemplary only and are variable according to anticipated uses for the screw 10. Also shown is concrete part 12. FIG. 1(b) is a plan view of FIG. 1(a) showing the nut 14 which is part of the screw casting, along with concrete part and concrete screw (it should be noted that the basic casting manufacturing process in which a material having liquid characteristics is poured into mold which contains a hollow cavity of the desired shape and then allowed to solidify, the solidified part then being ejected or broken out of the mold to complete the process, has been, known for centuries). Examples of additional thread dimensions are as follows:

Outer radius thread profile: 0.125 inches

Thread profile valley radius: 0.125 inches

Thread depth: 0.125 inches

FIG. 2 is a view of the bottom surface 16 of an object 10 that has multiple threaded screws, or rods, 10 (six illustrated) inserted, adjustment of the concrete screws being accomplished by using a wretch to rotate molded nut 14 to determine the height of each rod and thus the height of object 18 above the surface upon which it is placed.

FIG. 3 illustrates a threaded rod 10 secured to the bottom of surface of object 10.

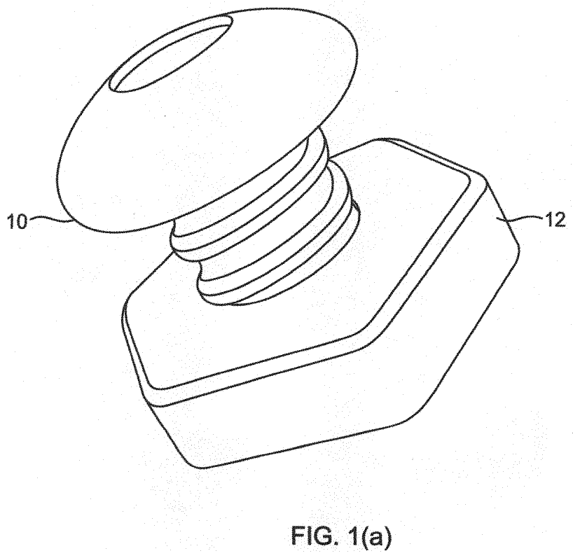

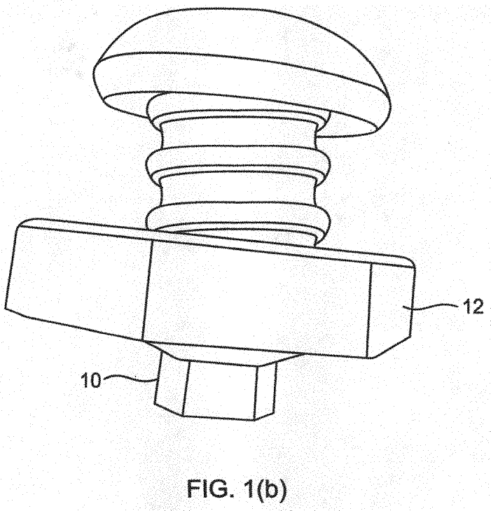

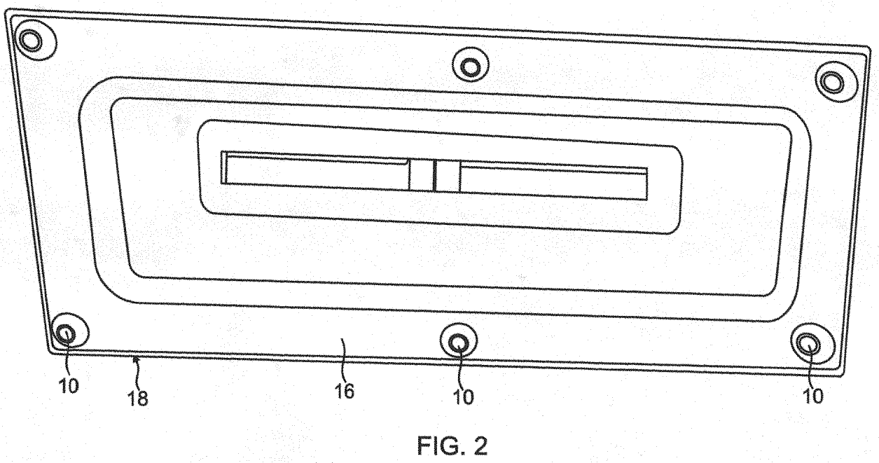

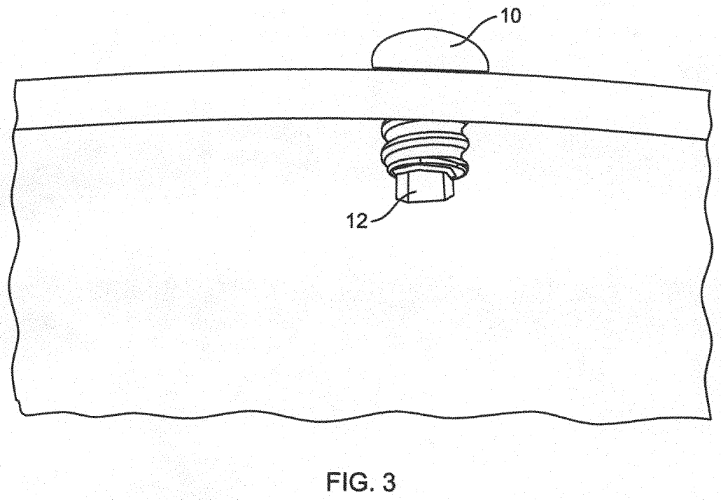

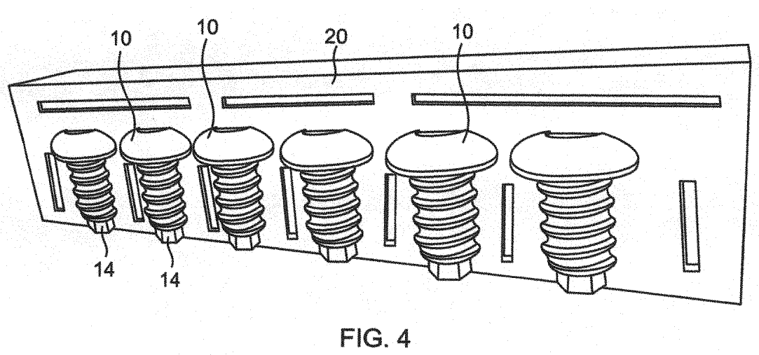

FIG. 4 illustrates one-half of mold 20 having concrete threaded rods d10 with integral concrete nuts 14 already cast.

The steps used to fabricate the concrete threaded rod, nut and receiving part used in the present invention are as follows:
1. The threaded rod and nut dimensions are drawn;
2. A digital model is fabricated using a 3d printing technology;
3. A silicon mold is utilized to recreate the 3d model multiple times for production casting of multiple parts per mold;
4. A two-part production mold (preferably fabricated from urethane) is made to cast multiple leveling feet;
5. Urethane rubber “knockouts” are fabricated and placed in the mold portion that is to form the female portion of the part to ensure that its threads stay clean and unobstructed after the concrete has′cured;
6. The concrete is then cast in the mold and allowed to harden after which the concrete threaded rod, nut and the cast concrete part are removed from the mold (note that separate molds can be used to cast each part if so desired);
7. The concrete leveling feet are threaded into the void space created by the urethane rubber knockouts in the cast concrete part; and
8. The adjustment feature provides needed ventilation for the fire related object without compromising its design.

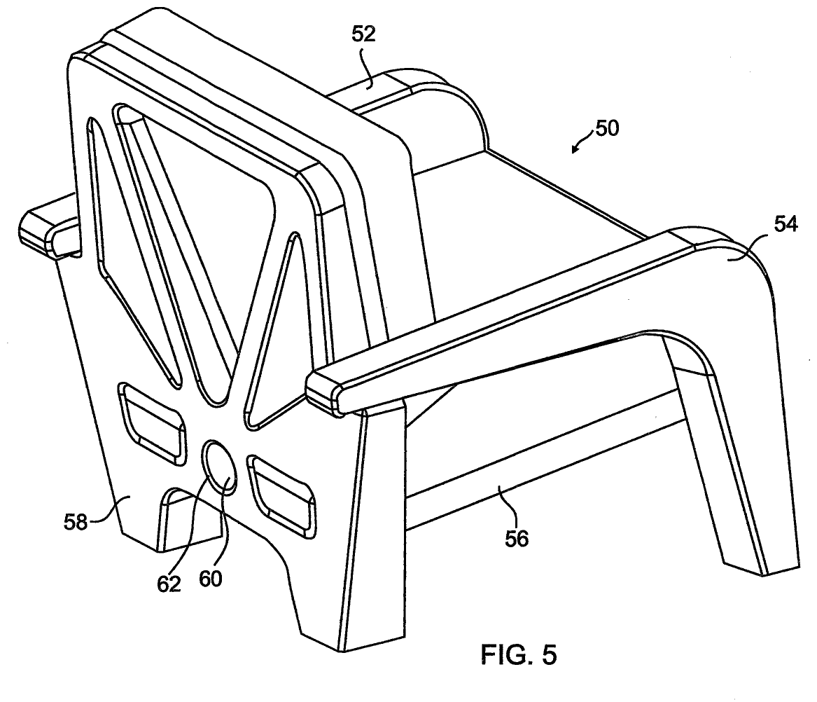

The present invention, in one embodiment, is adapted for use with outdoor related objects such as fire bowls, fire tables, fire pits, outdoor fireplaces and water bowls and outdoor furniture that are positioned on uneven surfaces. The concrete receiving part (secured to selected areas on the bottom surface of the object) and the corresponding concrete threaded rod are thus particularly adapted for leveling purposes which, in turn, prevents the object from rocking. The receiving part, although preferably formed of concrete, can also be fabricated from wood, metal or plastic for example. Although the present invention is adapted for use in outdoor related objects as noted above, it is anticipated that new uses for the concrete threaded rod and concrete nut combination will be developed in the Mare. In this regard, referring to FIG. 5, a perspective view of a lawn chair 50 is illustrated. Chair 50 comprises arms 52 and 54, seat 56, back 58 and aperture for receiving concrete screw 62.

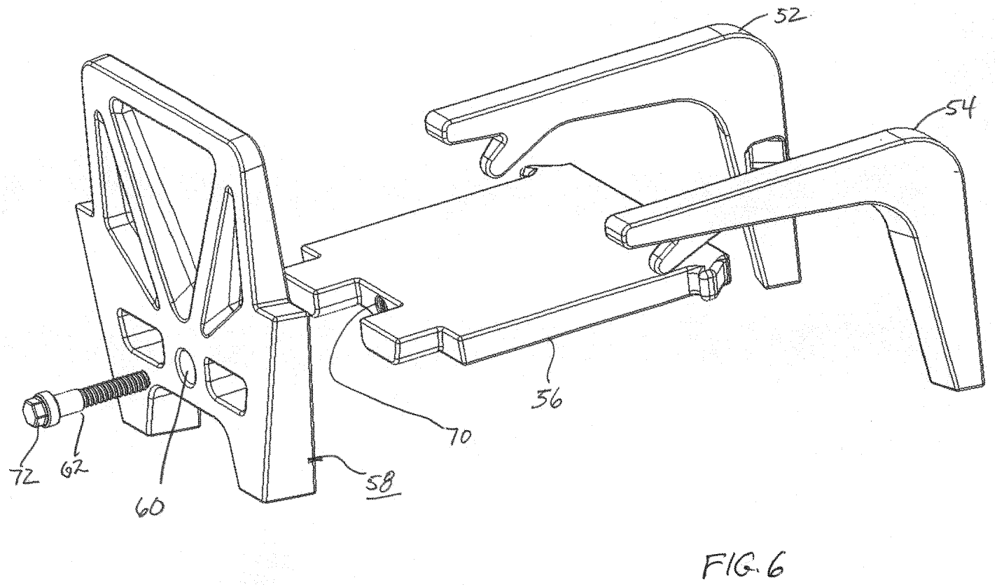

FIG. 6 is a view of chair components prior to being assembled into the chair 50 shown in FIG. 5. A threaded recess 70 is formed in seat 56 to receive concrete screw 62 when nut 72 is rotated by an appropriate tool. It should be noted that other means can be used to enable concrete screw 62 to mate, such as a slotted screw head in conjunction with a screwdriver.

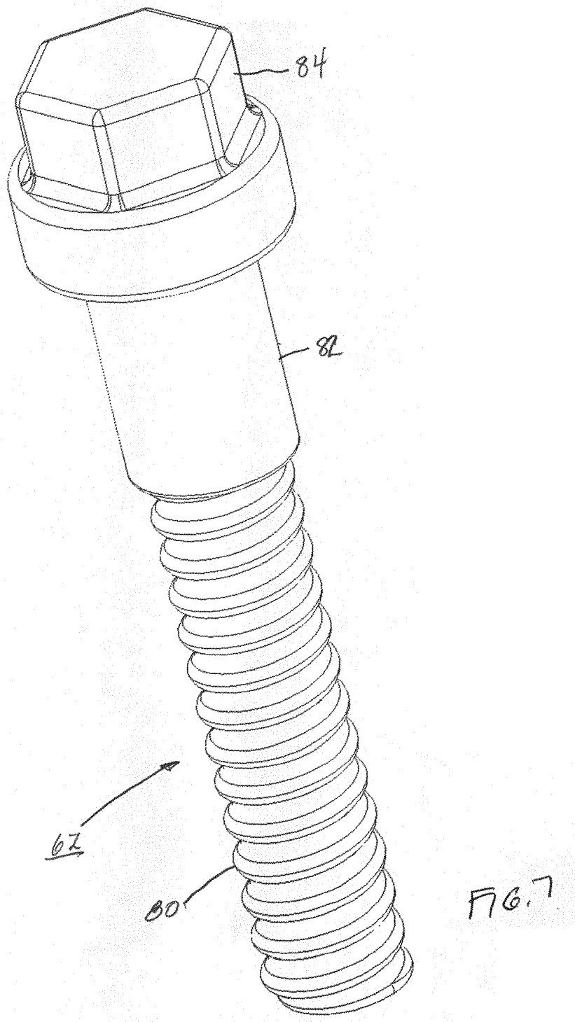

FIG. 7 illustrates the concrete screw 62 of the present invention and comprises threaded rod portion 80, cylindrical head 82 and nut 84. As noted with respect to the description of FIGS. 1-4 hereinabove, concrete components 80, 82 and 84 are preferably formed using a casting process in a manner whereby each of the components are formed at the same time, the result being in an integral unit.

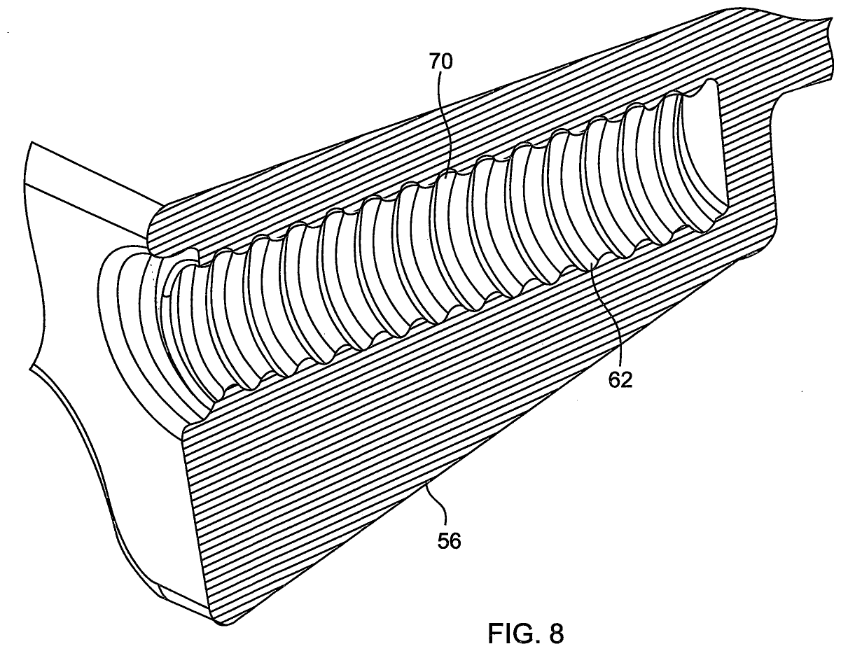

FIG. 8 illustrates concrete screw 62 inserted into recess 70, whereby back 58 is secured to seat 56.

FIGS. 5-8 thus illustrate how a concrete screw is utilized to join two concrete parts together. Note that this technique can be used to join concrete parts together to form a structure other than chair 50.

It should be noted that the threaded rod/screw assembly may be built with various reinforcements installed in the concrete receiver to improve overall strength, such as metallic or non-metallic rods, the concrete being cast/poured around or over the reinforcement members while in the mold. To facilitate easier rotation of the component parts, ingredients that provide this feature is added to the concrete mix. Once the threaded concrete device is installed and positioned correctly, it can be secured, or locked, in place by filling cavities, or voids, in the assembly with additional concrete or a particular polymer. When the added substance hardens, the concrete screw can no longer be rotated or adjusted. Finally, the threaded rod and its corresponding receiver component can be produced in large scaled paths for leveling large and heavy structures, such as buildings, building parts and pool decks.

While the invention has been described with reference to its preferred embodiments, it will be understood by those skilled in the art that various changes may be made, and equivalents may be substituted for elements thereof without departing from the true spirt and scope of the invention. In addition, many modifications may be made to adapt a particular situation or material to the teaching of the invention without departing from its essential teachings.

What is claimed is:

1. A concrete system for adjusting the height and preventing a rocking motion of an object, said object having a bottom surface, the system comprising a concrete threaded rod and a corresponding threaded part for receiving said concrete threaded rod, the corresponding receiving part being affixed to a selected area of the bottom surface of said object.

2. The concrete system of claim 1 wherein said object is positioned on an uneven surface prior to adjusting the height of said object.

3. The concrete system of claim 1 further including a concrete part that enables said threaded rod to be rotated.

4. The concrete system of claim 3 wherein said concrete threaded rod and said concrete part are formed as an integral unit.

5. The concrete system of claim 4 wherein rotation of said concrete part adjusts the height of said object.

6. A concrete system for fastening a first and second part together, said concrete system comprising a concrete threaded rod associated with said first part and a threaded concrete receiving aperture associated with said second part.

7. The concrete system of claim 6 wherein said first and second parts are concrete.

8. The concrete system of claim 6 further including a concrete member which is adapted to receive a tool that enables said threaded rod to be rotated.

9. The concrete system of claim 8 wherein said concrete threaded rod and said concrete member are formed as an integral unit.
